(19) United States
(12) Patent Application Publication
(10) Pub. No.: US 2025/0217688 A1
(43) Pub. Date: Jul. 3, 2025

(54) Privacy-Preserving Quantum Computation Using Masked Quantum Circuit

(71) Applicant: Google LLC, Mountain View, CA (US)

(72) Inventor: Ramis Movassagh, Santa Monica, CA (US)

(21) Appl. No.: 18/401,193

(22) Filed: Dec. 29, 2023

(51) Int. Cl. G06N 10/60

(52) U.S. Cl. CPC G06N 10/60

(57) ABSTRACT

Systems and methods for quantum computation are provided. In one example, performing quantum computation using a masked circuit can include obtaining, by a classical computing system, data indicative of a quantum computation circuit. One or more quantum gates within the circuit can be masked to generate a masked quantum computation circuit. Data indicative of the masked quantum computation circuit can be sent to a quantum computing system. The classical computing system can receive masked results associated with one or more quantum computations based on the masked quantum computation circuit. The classical computing system can determine, based on the masked results, an output of the quantum computation circuit.

### FIELD

The present disclosure relates generally to systems and methods for quantum computing.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a|0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

Example aspects of the present disclosure provide an example method. In some implementations, the example method can include obtaining, by one or more computing devices, data indicative of a quantum computation circuit comprising a plurality of quantum gates. The example method can include masking, by the one or more computing devices, one or more of the plurality of quantum gates to generate a masked quantum computation circuit. The example method can include sending, by the one or more computing devices, data indicative of the masked quantum computation circuit to a quantum computing system. The example method can include receiving, by the one or more computing devices, one or more masked results associated with one or more quantum computations based at least in part on the masked quantum computation circuit. The example method can include determining, by the one or more computing devices, an output of the quantum computation circuit based on the masked results.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts a block diagram of an example system for performing a masked quantum computation according to example embodiments of the present disclosure.

FIG. 2 depicts an illustration of an example masking function according to example embodiments of the present disclosure.

FIG. 3 depicts an illustration of a system for determining a target result based on one or more masked results according to example embodiments of the present disclosure.

FIG. 4 depicts a block diagram of an example quantum computing system according to example embodiments of the present disclosure.

FIG. 5 depicts a flowchart diagram of an example method for using a classical computing system to request a masked quantum computation according to example embodiments of the present disclosure.

FIG. 6 depicts a flowchart diagram of an example method for using a quantum computing system to perform a masked quantum computation according to example embodiments of the present disclosure.

FIG. 7 depicts a flowchart diagram of an example method for performing a quantum computation according to example embodiments of the present disclosure.

FIG. 8 depicts a block diagram of an example network of classical computing systems and quantum computing systems according to example embodiments of the present disclosure.

FIG. 9 depicts a block diagram of an example computing device according to example aspects of the present disclosure; and

FIG. 10 depicts a block diagram of an example computing device according to example aspects of the present disclosure.

### DETAILED DESCRIPTION

### Overview

Example aspects of the present disclosure are directed to systems and methods for quantum computation using masked quantum circuits. For example, a user (e.g., scientific research lab, etc.) who does not own a quantum computing system may wish to delegate a quantum computation to a quantum computing provider. However, the user may not wish to reveal the details of the computation to the quantum computing provider (e.g., the user may wish to preserve trade secrets, etc.). Systems and methods according to examples of the present disclosure can, for instance, facilitate privacy-preserving delegation of quantum computations using masked quantum circuits.

In particular, a classical computing device (e.g., user device) can obtain a target quantum computation circuit design and can generate a masked quantum circuit design based on the target quantum circuit design. A quantum computing device can perform quantum computations based on the masked circuit design to generate masked results, which can be communicated to the classical computing device. Based on the masked results, the classical computing device can determine a target result associated with the target quantum computation circuit.

Generating a masked circuit can comprise replacing one or more target quantum gates of the target circuit with one or more masked quantum gates. A first masked quantum gate can be determined, for instance, by randomly sampling from all possible quantum gates (e.g., according to a uniform distribution).

In some instances, performing quantum computations based on the masked circuit design can include performing quantum computations using a plurality of quantum circuits (e.g. a plurality of similar quantum circuits). For example, in some instances a first masked gate and target gate can be used to define a masking function (e.g. continuous function) describing a plurality (e.g. an infinite number) of additional masked quantum gates. In such instances, for example, a circuit similar to the masked circuit design can be generated by replacing a masked quantum gate with a quantum gate that is near the masked quantum gate on a curve describing the masking function. A plurality of quantum measurement results can then be generated using a plurality of similar quantum circuits (e.g., multiple measurement results per similar circuit, etc.).

In one example aspect, systems and methods are provided for determining privacy-preserving masking functions that can be efficiently combined with other systems and methods of the present disclosure. In one example aspect, a masking function can be defined based on a Cayley function, e.g. (1+i*θ)/(1−i*θ), where i can be the square root of −1, and θ can be a real-number-valued input variable. For example, in some instances, a hermitian matrix can be generated based on a target unitary matrix associated with a target quantum gate and a masked unitary matrix associated with a first masked quantum gate (e.g. a masked gate randomly selected from a Haar uniform distribution). A masking function can then be defined as a Cayley function taking a real-numbered multiple of the hermitian matrix as input and generating a corresponding unitary matrix as output. Each unitary matrix can define an alternate masked quantum gate, which can replace the first masked quantum gate to generate a similar circuit.

In some instances, determining a target result can comprise using a plurality of measurement results to determine a function describing a relationship between a plurality of quantum gates and a plurality of output values. For example, in some instances, a masking function associated with a masked quantum gate can comprise a function (e.g. a Cayley function) configured to map from a real number to a corresponding unitary matrix describing a quantum gate. In such instances, each quantum measurement result can be associated with a real number, wherein the real number maps to a quantum gate of a quantum circuit used to obtain the measurement result. In such instances, a relationship between the measurement results and corresponding real numbers can be determined, e.g. using error-corrected interpolation. This determination can be made by, for example, a user device or a device (e.g. classical computing system) associated with a quantum computing provider.

Determining a target result can further comprise determining, based on the relationship between the plurality of quantum gates and plurality of output values, an output value associated with the target quantum circuit. For privacy-preserving delegation of quantum computation, this determination can be made by a user device, without revealing the target quantum circuit to a quantum computing provider.

In some instances, a precision of the target result can be determined based on a precision of the masked results and a distance metric (e.g. total variational distance) between the masked quantum computation circuit and the target quantum computation circuit. In some instances, a tolerance associated with the target result can be obtained beforehand, and a tolerance associated with the masked results can be determined based on the target tolerance and a distance metric between the masked quantum computation circuit and the target quantum computation circuit. In some instances, a quantum computing provider can determine a number of quantum computations or quantum measurements to be determined based on the tolerance associated with the masked results. This determination can also be based on one or more properties of the quantum computing system (e.g. fidelity, coherence time, etc.).

In some instances, the classical computing system can also verify one or more masked results (e.g. by comparing a result to a known or expected result, e.g. by verifying, in polynomial computing time, a result associated with an NP-hard problem; by simulating a portion of the masked quantum computing circuit and comparing the provided results to the simulation; etc.).

Systems and methods of the present disclosure provide a number of technical effects and benefits. For example, systems and methods of the present disclosure can enable privacy-preserving delegation of a quantum computation to a quantum computing provider. In some instances, masking functions of the present disclosure can generate a masked quantum circuit associated with a large (e.g. infinite) number of possible target quantum circuits, such that a quantum computing provider is unlikely to be able to determine a user's target quantum computation circuit based on the masked quantum circuit.

In some instances, systems and methods according to examples of the present disclosure can perform privacy-preserving quantum computations more efficiently than prior methods (e.g. simulating a full quantum circuit using a classical computer). For example, in some instances, a complexity associated with systems and methods of the present disclosure can be polynomial in relation to a number of masked gates associated with a masked quantum circuit (which can be smaller than a total number of gates in the target quantum circuit). In contrast, prior systems and methods for privacy-preserving quantum computation (e.g. classical computing simulation) can in some instances have a complexity that is exponential in relation to a size of a target quantum circuit.

In some instances, a polynomial efficiency associated with systems and methods of the present disclosure may allow for performance of tasks that can be difficult and/or significantly non-trivial to practically perform using a classical computing system. For example, tasks having exponential complexity may become practically impossible when a problem size becomes too large, even if the task is easy at small problem sizes. For example, a 256-bit RSA encryption can be decrypted (“cracked”) in under one minute through brute force computation, but a problem only eight times as large (2048-bit RSA encryption) would take trillions or quadrillions of years to decrypt using present-day classical computers. In contrast, a system or method having polynomial complexity can in some instances scale to large problem sizes more efficiently. As one illustrative example, if a system or method has a polynomial complexity of O(n²) and can perform a small computation in under one minute, then the same system or method may perform a computation eight times larger in approximately sixty-four minutes rather than quadrillions of years. Thus, systems and methods of the present disclosure may in some instances may provide privacy-preserving computations that can be difficult to perform without quantum methods.

With reference now to the Figures, example embodiments of the present disclosure will be discussed in further detail.

### Example Discussion of Quantum Computing Notation

A quantum computation can comprise initializing a state of one or more qubits and then performing a computation to change a state of the one or more qubits. In some instances, a state of one or more qubits can be written as a vector in Hilbert space. For example, a system of three qubits may have eight basis states (e.g. |0 [symbol] |0 [symbol] |0 [symbol] , |0 [symbol] |0 [symbol] |1 [symbol] , etc.). A horizontal vector of length eight can represent the eight basis states, and a superposition of multiple basis states can be represented by eight numbers (e.g. real numbers, complex numbers) in the vector. Such a vector can be called a “ket” and can be abbreviated using “ket” notation (e.g., |0³ [symbol] can represent the basis state |0 [symbol] |0 [symbol] |0 [symbol] , which can correspond to the eight-entry vertical vector [1, 0, 0, 0, 0, 0, 0, 0], where the 1 represents a 100 percent chance of obtaining the basis state |0 [symbol] |0 [symbol] |0 [symbol] if a measurement of the quantum system is performed). A superposition of more than one basis state can be written as, e.g., [0.5, 0.5, 0.5, 0.5, 0, 0, 0, 0]. A probability of a quantum measurement returning a particular basis state can be equal to the square of a corresponding entry in the ket (e.g. 0.5²=25 percent chance of measuring the basis state |0 [symbol] |0 [symbol] |0 [symbol] if a measurement is performed).

In some instances, a hermitian conjugate of a ket can be written as a “bra” (the other half of a “bra-ket” or bracket). A hermitian conjugate can be generated by transposing the rows and columns of the ket, then taking a complex conjugate of each complex number (e.g. 1+2i in the third row of the vertical ket can become 1−2i in the third column of the horizontal bra), leaving real numbers unchanged.

A matrix multiplication [symbol] x∥x [symbol] can generate a real number (e.g. one) that is the sum of the squares of the entries in the ket |x [symbol] (e.g. a sum of measurement probabilities associated with each basis state of the ket). In contrast, a matrix multiplication |x [symbol] [symbol] x| can generate a square matrix having a number of rows and columns equal to a number of rows in the ket |x [symbol] .

In some instances, one or more quantum operations can be performed on a system of qubits having a state represented as a ket. The operations can be written as a square matrix having a number of rows and columns equal to the number of entries in a ket the circuit acts on (e.g. 2ⁿ^{_{qubits}}, where n_{qubits} is a number of qubits in a quantum system the circuit acts on). For example, the matrix multiplication C|0ⁿ^{_{qubits}} [symbol] =|ψ [symbol] can represent a circuit acting on n_{qubits} qubits with an initial state of |0 [symbol] and generating an output quantum state represented by the ket |ψ [symbol] , where C is a unitary square matrix having 2ⁿ^{_{qubits}} rows and 2ⁿ^{_{qubits}} columns. Thus, a square unitary matrix having n_{rowcol} rows and n_{rowcol} columns can define a quantum circuit or quantum gate acting on a quantum system having n_{rowcol} possible quantum states (e.g., a 2×2 square matrix representing a quantum gate acting on one qubit, a 4×4 square matrix representing a 2-qubit quantum gate, etc.).

A unitary matrix is a matrix whose hermitian adjoint is also its inverse, such that C^{†}C=I, where I is the identity matrix and C^{†} (optionally pronounced “c-dagger”) is a hermitian conjugate of C.

In some instances, a square “operator” matrix can be defined, which can be distinct from a square unitary matrix associated with a quantum circuit. For example, in some quantum computing implementations a quantum measurement can measure a basis state of a first qubit in an n-qubit quantum system whose quantum state is written as |x [symbol] . In such instances, a probability that the first qubit will be measured at |0 [symbol] can be defined by the matrix multiplication [symbol] x|M₀|x [symbol] , where the square matrix M₀ can have entries equal to one for all basis states where the first qubit is |0 [symbol] , and entries equal to zero for all basis states where the first qubit is |1 [symbol] (e.g. |0 [symbol] ₁ [symbol] 0|₁, where |0 [symbol] ₁ is a vertical matrix having a value of one for each entry associated with a first qubit in basis state |0 [symbol] , e.g. [1, 1, 1, 1, 0, 0, 0, 0] in a three-qubit system.

More generally, observable (e.g. measurable) quantum values can in some instances be written as a square operator matrix O, and an expected value of the observable (e.g. an expected probability of measuring basis state |0 [symbol] ) can be represented by [symbol] x|O|x [symbol] , where x is a quantum state of the quantum system at a time of measurement.

Where a circuit represented by the unitary matrix C has acted on a quantum system with an initial state of |0 [symbol] for all qubits (written as C|0ⁿ^{_{qubits}})=|ψ [symbol] ), an observable quantum value can be written as [symbol] ψ|O|ψ [symbol] , which can be equivalent to [symbol] ψ|C^{†}OC|ψ [symbol] , where C^{†} can be a hermitian conjugate of C.

### Example Architectures

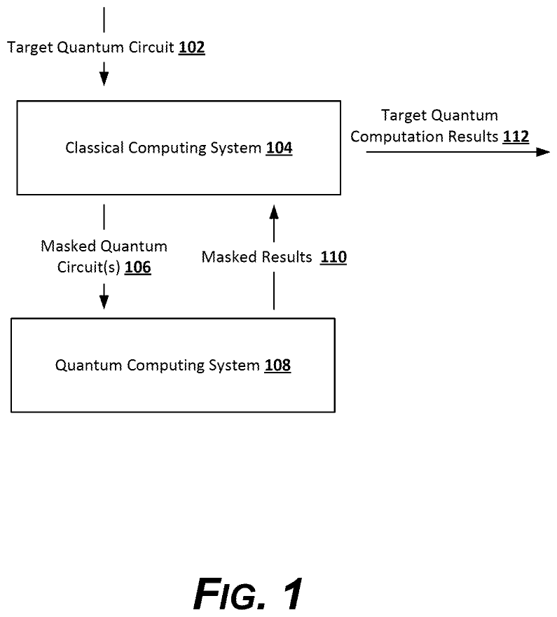

FIG. 1 depicts a block diagram of an example system for performing a masked quantum computation according to example embodiments of the present disclosure. A target quantum circuit 102 can be obtained by a classical computing system 104, and the classical computing system 104 can generate one or more masked quantum circuits 106 based in part on the target quantum circuit 102. The classical computing system can send the masked quantum circuit 106 to a quantum computing system 108, which can implement the masked quantum circuit 106 to generate masked results 110. Based on the masked results 110, the classical computing system 104 can generate target quantum computation results associated with the target quantum circuit.

The target quantum circuit 102 can be, for example, any computer-readable data indicative of a circuit of interest or algorithm of interest configured to be implemented on a quantum computer (e.g. quantum circuit design, wire diagram, quantum programming language code, etc.). In some instances, the target quantum circuit 102 can comprise one or more quantum gates, which can each be associated with a unitary matrix describing the quantum gate. For example, a quantum computation can be seen as equivalent to the application of a unitary matrix (e.g., a rotation in Hilbert space) to an initial state of one or more qubits. In such instances, a quantum circuit or quantum gate can be defined by one or more unitary matrices and vice versa. In some instances, an entire quantum circuit can also be defined by a single unitary matrix (e.g. a square unitary matrix having 2ⁿ^{_{qubits}} rows and 2ⁿ^{_{qubits}} columns, where n_{qubits} is a number of qubits associated with a quantum computation of the quantum circuit) and vice versa.

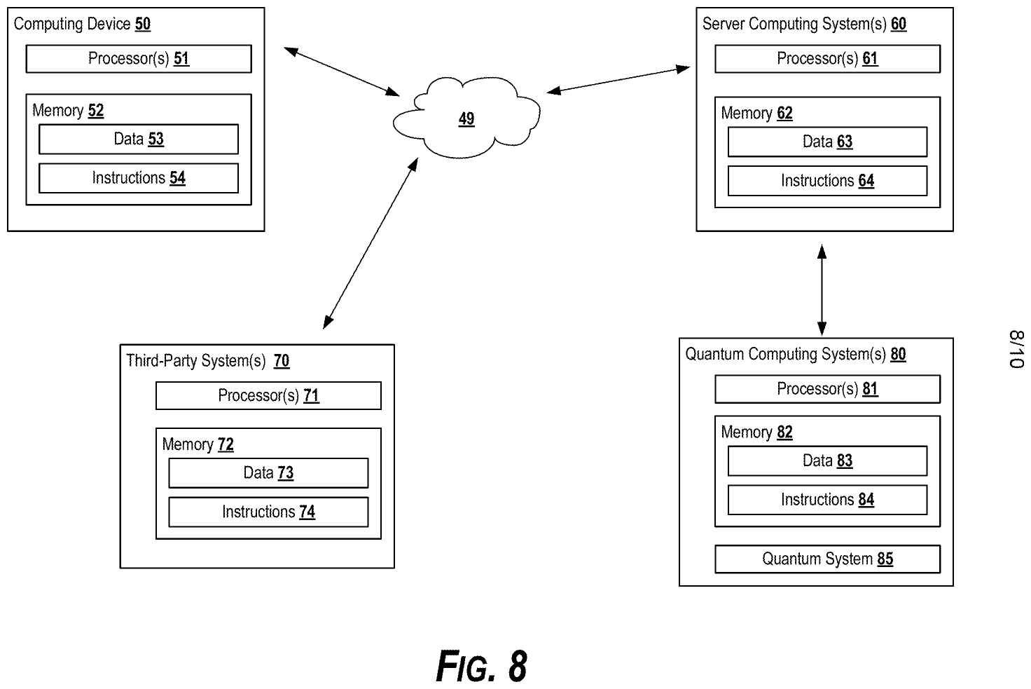

The classical computing system 104 can comprise one or more computing devices which can be, for example, one or more computing devices described with respect to FIG. 8-10.

The masked quantum circuit(s) 106 can be, for example, any computer-readable data indicative of a circuit or algorithm configured to be implemented on a quantum computer (e.g. quantum circuit design, wire diagram, quantum programming language code, etc.). In some instances, the target quantum circuit 102 can comprise one or more quantum gates, which can each be associated with a unitary matrix describing the quantum gate.

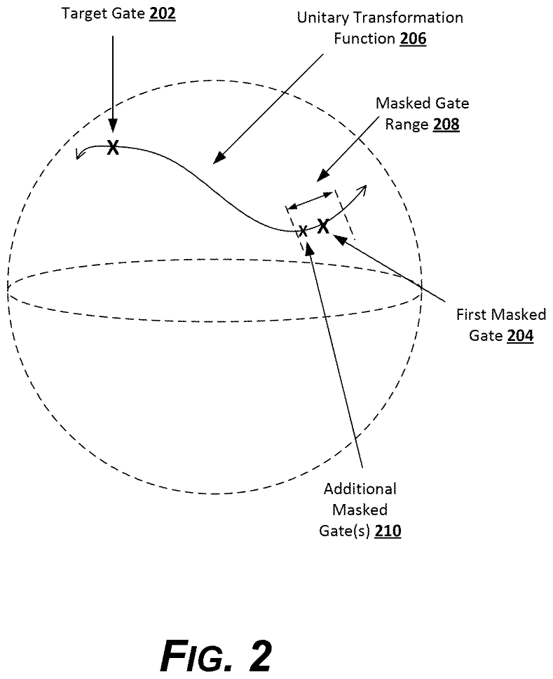

In some instances, generating the masked quantum circuit(s) 106 can comprise randomly selecting one or more masked quantum gates (e.g. from a uniform distribution according to a Haar measure, e.g. a probability measure that is translation-invariant over the set of all possible quantum gates). In some instances, generating the masked quantum circuit(s) 106 can comprise determining one or more masking function(s) associated with one or more quantum gates of the target quantum circuit 102. In such instances, generating the masked quantum circuit(s) 106 can further comprise determining one or more masked quantum gates based on the masking function. Example implementations of generating one or more masked quantum gates based on one or more masking functions are described below with respect to FIG. 2.

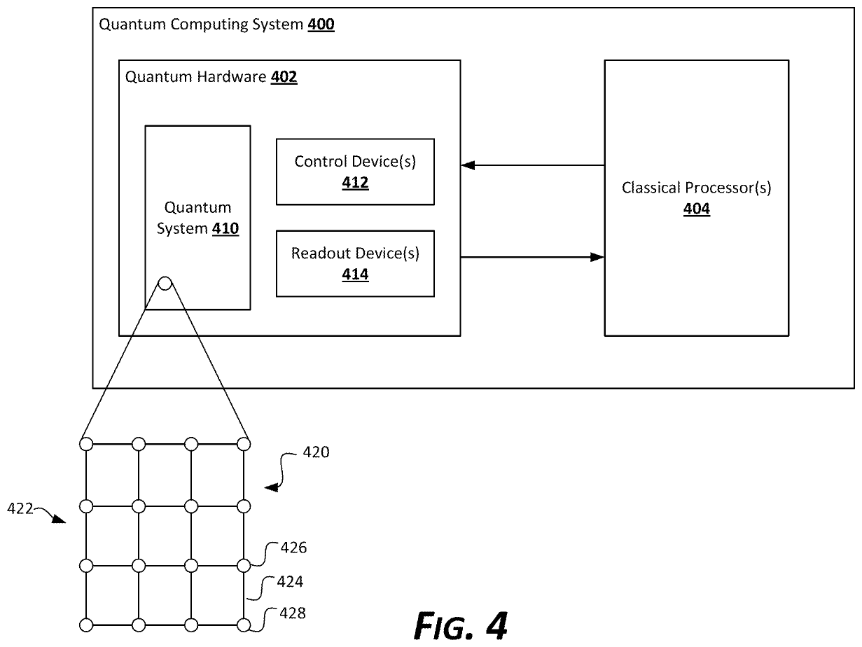

The quantum computing system 108 can be, for example, any system configured to perform a quantum computation based on a masked quantum circuit 106. In some instances, the quantum computing system 108 can comprise one or more classical computing devices (e.g. computing devices described with respect to FIG. 8-10) and one or more quantum devices. In some instances, the quantum computing system 108 can be or comprise one or more systems described with respect to FIG. 4 (e.g., quantum computing system 400, etc.).

The quantum computing system 108 can implement one or more quantum computations based on the masked quantum circuit 106 to generate masked quantum results 110. In some instances, implementing a quantum computation can comprise one or more steps or processes described below with respect to FIG. 4.

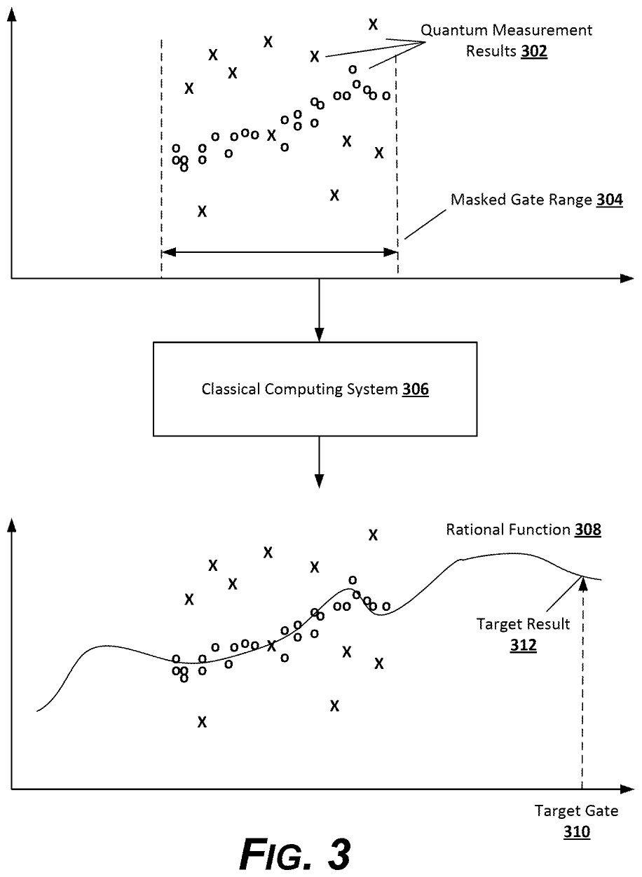

The masked results 110 can comprise, for example, data indicative of one or more measurements associated with one or more quantum computations. The measurements can comprise, for example, quantum basis measurements to determine a state of one or more qubits. In some instances, the masked results 110 can comprise one or more aggregated results based on a plurality of individual measurements (e.g. an expected value associated with a quantum observable, one or more probabilities associated with one or more quantum states, etc.). In some instances, the masked results 110 can comprise other data or metadata associated with one or more quantum computations (e.g. an estimated precision, etc.). In some instances, the masked results 110 can comprise data indicative of a relationship between a plurality of quantum gates and a plurality of output values, or between a plurality of quantum circuits and a plurality of output values. In some instances, data indicative of such a relationship can be generated in a manner described below with respect to FIG. 3.

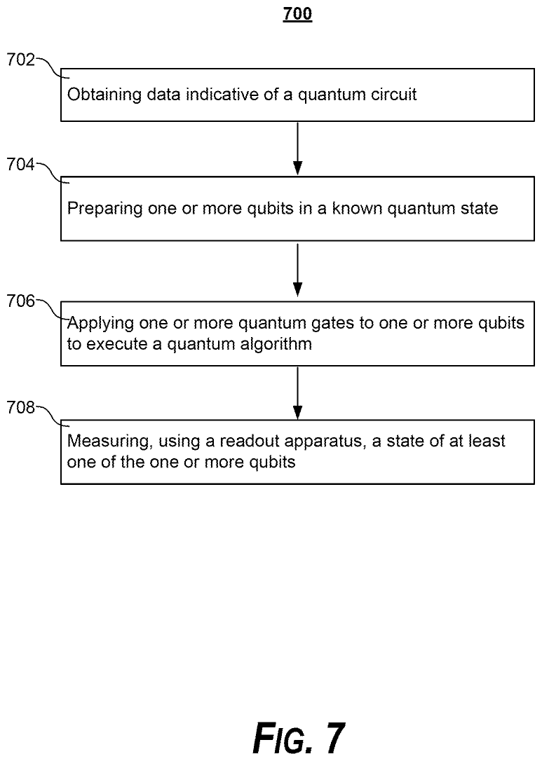

In some instances, generating the masked quantum results 110 can include performing one or more quantum computations (e.g. according to methods described with respect to FIGS. 4 and 7) to generate one or more quantum measurements. In some instances, generating the masked quantum results 110 can include one or more classical computing computations (e.g., generating statistical data based on one or more quantum measurements; generating data indicative of a relationship between a plurality of quantum gates and a plurality of output values, e.g., according to methods described with respect to FIG. 3; etc.).

The classical computing system 104 can determine one or more target quantum computation results 112 based on the masked results 110. Determining the target quantum computation results 112 can comprise, for example, obtaining a function describing a relationship between a plurality of respective masked circuits or respective masked gates and a plurality of respective quantum computation results. Obtaining the function can include, for example, receiving data indicative of the function (e.g. from a classical computing system associated with a quantum computing provider), generating the function based on the masked results 110, or any other appropriate means. Determining the target quantum computation results 112 can further comprise, for example, using the function to determine a quantum computation result associated with the target quantum circuit 102. Example methods for generating a function describing a relationship between a plurality of respective masked circuits or respective masked gates and a plurality of respective quantum computation results are provided below with respect to FIG. 3.

In some example implementations, the classical computing system 104 can also perform a verification step. The verification step can be designed to verify (e.g., determine with a high confidence level, e.g. above a specified probability threshold) that an untrusted quantum computing provider has provided accurate masked results 110 (e.g. within a specified precision, etc.) or that an untrusted quantum computing provider has provided quantum results rather than, e.g., results of a classical computing simulation of a quantum circuit. For example, in some instances a quantum circuit 102, 106 can comprise a quantum circuit configured to perform a computation that is difficult or impossible to perform within a specified time limit using a classical computing system. In some instances, a target quantum circuit 102 can be configured to perform a task that is known to be NP-hard, meaning that the task cannot be performed in polynomial time (e.g., time that scales polynomially with respect to a number of parameters associated with the task) but can be verified in polynomial time using a classical computing system. In such instances, a quantum computing system 108 can be provided with a short time limit and a masked quantum circuit 106 associated with an NP-hard target quantum circuit 102 that cannot be solved within the time limit by a known classical computing system. A classical computing system 104 (e.g. a user device) can then verify the masked results 110 by generating target quantum computation results 112 and then verifying the target quantum computation results 112 in polynomial time. In other instances, a quantum computing output can be verified by performing a classical simulation of a portion of a masked quantum circuit 106 and performing a comparison between the masked results and a result of the simulation. See, e.g., U.S. patent application Ser. No. 17/221,291. In some instances, a verification process can be repeated a plurality of times for a plurality of target quantum circuits 102 (e.g., until a statistical confidence threshold is exceeded, e.g. until a user is X percent confident that an untrusted provider is providing accurate results, where X can be any percentage e.g. 99, 95, 80, 51, etc.). In some instances, a verification step can be performed based on a first target quantum circuit 102 (e.g. one known to be NP-hard) before or after performing quantum computations on a second target quantum circuit 102 (e.g. a circuit that may be more difficult to verify in polynomial time).

The target quantum computation results 112 can be, for example, any computer-readable data (e.g. numerical data, boolean data, etc.) indicative of one or more quantum computation results (e.g. quantum basis measurements, aggregated statistical values, etc.) that would have resulted from a quantum computation based on the target quantum circuit 102.

FIG. 2 depicts an illustration of an example masking function according to example embodiments of the present disclosure. FIG. 2 depicts a Bloch sphere, wherein the surface of the Bloch sphere can represent a plurality of possible unitary matrices associated with a plurality of possible quantum gates. A target gate 202 associated with a target quantum circuit 102 can be selected for masking, and a first masked gate 204 can be determined (e.g. based on random sampling). Based on the first masked gate 204 and the target gate 202, a unitary transformation function 206 can be plotted between the first masked gate 204 and the target gate 202. A masked gate range 208 can be obtained, and one or more additional masked gates 210 can be generated based on the masked gate range 208 and the unitary transformation function 206.

The target gate 202 can be, for example, a quantum gate of the target circuit 102. In some instances, the target gate 202 can be associated with a unitary matrix having a number of rows and a number of columns. In some instances, the number of rows can be equal to the number of columns. In some instances, the number of rows can be equal to two or four (e.g., corresponding to a quantum gate acting on one qubit or two qubits respectively). In some instances, the target gate 202 can comprise or be implemented by quantum hardware described with respect to FIG. 4.

The masked gate 204, can be, for example, a quantum gate of the masked quantum circuit 106. In some instances, the masked gate 204 can be associated with a unitary matrix having a number of rows and a number of columns. In some instances, the number of rows and number of columns can be equal to a number of rows and number of columns, respectively, of the target gate 202. In some instances, the number of rows can be equal to two or four. In some instances, the masked gate 204 can be selected by random sampling (e.g. sampling from a uniform distribution over a plurality of quantum gates according to a Haar measure, e.g. a uniform distribution over all possible quantum gates). In some instances, the masked gate 204 can comprise or be implemented by quantum hardware described with respect to FIG. 4.

The unitary transformation function 206 can comprise, for example, a function having a domain comprising one or more real numbers (e.g. all real numbers) and a range comprising one or more quantum gates or data indicative of one or more quantum gates. For example, in some instances the unitary transformation function 206 can have a domain comprising one or more unitary matrices, wherein each unitary matrix can describe a corresponding quantum gate. In some instances, the unitary transformation function 206 can comprise an interpolation path between a unitary matrix corresponding to the target gate 202 and a unitary matrix corresponding to the masked gate 204. In some instances, an interpolation path of the unitary transformation function 206 can be a unitary-valued interpolation path, wherein every point on the path is a unitary matrix.

In some instances, the unitary transformation function 206 can comprise a Cayley function. In some instances, the Cayley function can be written as

$$f ( θ ) = \frac{( 1 + i * θ )}{( 1 - i * θ )} ,$$

wherein i is the square root of negative one and θ is a real-number-valued input variable. In some instances, a unitary-valued interpolation path can be determined based on the Cayley function. In some instances, a unitary-valued interpolation path can be generated by first generating a hermitian matrix based on the target gate 202 and masked gate 204, and then performing the Cayley function on the hermitian matrix to generate a unitary matrix. For example, in some instances the Cayley function can be configured to map the real eigenvalues of the hermitian matrix to the complex eigenvalues of the target gate 202 when θ is equal to a particular value (e.g. one) and map the eigenvectors unchanged. In some instances, the hermitian matrix can be generated by computing an inverse Cayley function of a matrix generated by multiplying a hermitian adjoint of a unitary matrix of the target gate 202 by a unitary matrix of the first masked gate 204. This can be written as h=f⁻¹_{(T†M)}, where h is the generated hermitian matrix, T is a unitary matrix of the target gate 202, M is a unitary matrix of the first masked gate 204, f is a Cayley function, and † (optionally pronounced “dagger”) is a hermitian adjoint operator. In some instances, an inverse Cayley function can be written as

$$( \frac{1 - x}{1 + x} ) .$$

In some instances, the unitary transformation function 206 can be written as U(θ)=T*f(θh), where T is a unitary matrix of the target gate 202, h is a hermitian matrix based on the target gate 202 and first masked gate 204, and U is the unitary transformation function 206, which can take a real-number-valued input variable θ and generate a corresponding unitary matrix as output. In instances where the unitary transformation function 206 is U(θ)=T*f(θh), U(0) can be equal to a unitary matrix of the target gate 202 (e.g., TI, where I is an identity matrix), and U(1) can be equal to a unitary matrix of the first masked gate 204 (e.g., TT^{†}M).

In some instances, a spectral decomposition of the hermitian matrix can be used in determining the unitary transformation function 206 or in performing computations based on the unitary transformation function 206. In some instances, one or more eigenvectors of a masked gate 204, 210 can be computed, and a spectral decomposition of the hermitian matrix can be based in part on the one or more eigenvectors. For example, if the eigenvectors of a masked gate 204, 210 are written such that |ψ_{α} [symbol] is the α-th (e.g. first, second, etc.) eigenvector, then a spectral decomposition of the hermitian matrix can be written as h=Σ_{α=1}ⁿf(θh_{α})|ψ_{α} [symbol] [symbol] ψ_{α}|, where n is a number of rows of a unitary matrix of the target gate 202, fis a Cayley function, θ is a real-number-valued input to the Cayley function, and h is the hermitian matrix. In such instances, a unitary transformation function 206 can be written U(θ)=Σ_{α=1}ⁿT*f(θh_{α})|ψ_{α} [symbol] [symbol] ψ_{α}|, where U is the unitary transformation function 206 and T is a unitary matrix of the target gate 202. In such instances, an induced unitary map associated with the unitary transformation function 206 can be written as

$$U ( θ ) = \frac{1}{{q}_{θ}} {\sum }_{α = 1}^{n} {u}_{α} ( θ ) * T \vert {ψ}_{α} 〉 〈 {ψ}_{α} \vert ,$$

where q(θ)=Π_{α=1}ⁿ(1−iθh_{α}), u_{α}(θ)=(1+iθh_{α})*Π_{β∈[n]\α}(1−iθh_{β}), |ψ_{α} [symbol] is an α-th eigenvector of a masked gate 204, 210 and [symbol] ψ_{α}| is its hermitian adjoint.

FIG. 2 also depicts a masked gate range 208. The masked gate range 208 can be, for example, any computer-readable data indicative of a plurality of quantum gates. In some instances, the masked gate range 208 can comprise a plurality of real numbers (e.g. all real numbers between two endpoints of a span of real numbers). In some instances, a plurality of real numbers of the masked gate range 208 can be associated with a plurality of quantum gates based on the unitary transformation function 206 (e.g. when the unitary transformation function 206 is configured to take a real number as input and generate a unitary matrix or quantum gate as output corresponding to the real-numbered input). The masked gate range 208 can be obtained or generated, for instance, by a user device or by a device (e.g. classical computing device) associated with a quantum computing provider (e.g., if the hermitian matrix is generated by a user device and subsequently communicated to the quantum computing provider). In some instances, a narrow range of values comparatively close to the first masked gate 204 can be selected, and the target gate 202 can be outside the masked gate range 208. In other instances, a wider range or values can be used or the target gate 202 can be inside the masked gate range.

In some instances, one or more additional masked gates 210 can be generated based on the unitary transformation function 206 and a masked gate range 208. For example, in some instances a masked gate range may comprise a finite plurality of real numbers, and a masked gate can be generated using the unitary transformation function 206 for every real number in the masked gate range. In other instances, a finite plurality of real numbers can be determined (e.g. by random sampling) from a masked gate range 208 comprising an infinite plurality of real numbers.

In some instances, a quantity of additional masked gates 210 to generate can be determined based on a number nₘₐₛₖ of target gates 202 that have been masked from the target circuit 102. In some instances, a function for determining the target quantum results 112 can be a rational function comprising two polynomials having a degree of at most 8nₘₐₛₖ and 8nₘₐₛₖ. In some instances, a decision problem can be encoded in a measurement of one or more individual qubits; in such instances, a degree of the rational function can depend on a physical property of the qubits (e.g., a backward light cone of a single qubit being measured, etc.). A quantity of masked circuits required to interpolate a rational function of that degree can be determined based on a degree of the rational function and a number of expected measurement errors (based on, e.g., a fidelity associated with a quantum computing system 108 or masked quantum circuit 106). For example, in some instances a quantity of masked circuits can be greater than a sum of the degrees of the polynomial functions comprising a rational function 308 plus twice a number of expected measurement errors (e.g., 16nₘₐₛₖ+2t, where t is a number of expected measurement errors).

FIG. 3 depicts an illustration of a system for determining a target result based on one or more masked results according to example embodiments of the present disclosure. A plurality of quantum measurement results 302 associated with a plurality of masked gates within a masked gate range 304 can be received by a classical computing system 306. The classical computing system 306 can then determine a rational function 308 based on the quantum measurement results 302, wherein the rational function 308 can be indicative of a relationship between a plurality of quantum gates or plurality of quantum circuits and a plurality of quantum computation results. The classical computing system 306 can then determine a target result 312 based on a target gate 310 of the target quantum circuit 102.

FIG. 3 depicts quantum measurement results 302. In some instances, the quantum measurement results 302 may comprise one or more intended quantum computation measurements and one or more erroneous quantum computation measurements (e.g., due to quantum decoherence, e.g., due to disturbances associated with an environment of the quantum computing system). In some instances, a quantity of measurements 302 to generate for each masked gate in a masked gate range 304 can be determined based on, for example, a precision of the quantum computing system and a target precision associated with one or more target quantum computation results 112.

In some instances, one or more quantum measurement results 302 can be associated with a measurement precision. In some instances, a plurality of quantum measurement results 302 can be associated with an aggregate precision (e.g. a precision associated with a mean value of a plurality of quantum measurements 302). In some instances, an aggregate precision can be improved by generating additional quantum measurement results 302 to increase a sample size. For example, an error rate can in some instances be proportional to

$$\frac{1}{√ k} ,$$

where k is a number of times the quantum computing system 108 runs a particular masked quantum circuit 106. In some instances, a number of quantum measurement results 302 can be increased until a precision threshold is met.

In some instances, a masked precision goal can be determined for one or more masked results 110 (e.g., a mean value of a plurality of quantum measurement results 302) based on a target precision goal associated with a target result 112, 312. In some instances, the masked precision threshold can also be based on a degree of the rational function 308 and a total variational distance between a masked circuit 106 and a target quantum circuit 102. In some instances, a masked result 110 can be a probability associated with one or more qubits (e.g. a probability that a particular qubit is in a |1 [symbol] basis state upon measurement). In some instances where a unitary transformation function 206 and rational function 308 are determined according to methods of FIGS. 2 and 3, a masked precision goal can be

$$ϵ \frac{exp [ d ( 1 + log {Δ}^{- 1} ) ]}{√ 2 πd} ,$$

where d is a degree of the rational function 308, Δ is a total variational distance between a masked quantum circuit 106 and a target quantum circuit 102, and ϵ is a target precision goal associated with a target result 112, 312. In some instances, a number of gates to mask (nₘₐₛₖ) can be proportional to log(n) (i.e. O(log(n), where O is a “big-O” notation), such that a total variational distance from a masked quantum circuit 106 to a target quantum circuit 102 can be O(nₘₐₛₖΔ) by additivity of the total variational distance.

FIG. 3 depicts a masked gate range 304. In some instances, the masked gate range 304 can be, comprise, be comprised by, or otherwise share properties similar to a masked gate range 208.

FIG. 3 depicts a classical computing system 306. In some instances, the classical computing system 306 can be, comprise, or be comprised by a classical computing system 104 (e.g. user device) or a computing system (e.g. associated with a quantum computing provider) described with respect to FIG. 8-10.

FIG. 3 depicts a rational function 308. The rational function 308 can be, for instance, a mathematical function describing a relationship between a plurality of quantum circuits and a plurality of quantum computing results. In some instances, the rational function 308 can be based, at least in part, on one or more unitary transformation functions 206. For example, in some instances, a unitary transformation function 206 associated with a masked quantum gate can comprise a function (e.g. a unitary path comprising a Cayley function) configured to map from a real number to a corresponding unitary matrix describing a quantum gate. In such instances, each quantum measurement result can be associated with one or more real numbers (e.g. a real number associated with each masked gate 204, 210 in the circuit used to generate the measurement result). In such instances, a real number can map to a masked gate 204, 210 of a quantum circuit used to obtain the measurement result, and a plurality of real numbers can map to a quantum circuit comprising a plurality of masked gates 204, 210. In such instances, a rational function 308 describing a relationship between the measurement results and corresponding real numbers can be determined (e.g. using error-corrected interpolation, e.g. using Lagrange interpolation and/or Berlekamp-Welch error correction, solving a Vandermonde equation, performing a least-squares fit, etc.). The rational function 308 can be determined by, for example, a user device or a device (e.g. classical computing system) associated with a quantum computing provider.

In some instances, a method for determining a rational function 308 (e.g. error-corrected interpolation) can be based at least in part on a degree of a rational function associated with one or more unitary transformation functions 206. In some instances, a unitary transformation function 206 can comprise a Cayley path (e.g. a Cayley path described with respect to FIG. 2) and a unitary matrix of each target gate 202 can have either two rows and two columns or four rows and four columns. In example instances where only one gate is masked, a rational function 308 (e.g. based on a Cayley path) can be a rational function of degree (n_{rowcol}, n_{rowcol}) in which a numerator and denominator of the rational function 308 are each polynomials of degree n_{rowcol} (e.g., because of an algebraic form of a unitary transformation function 206, e.g. comprising a Cayley path), where n can be a number of rows of a square-shaped unitary matrix of a masked gate 204, 210. In example instances where a plurality of gates is masked, a rational function 308 describing an x, y entry of a unitary matrix of a masked circuit 106 can be a rational function with respect to a real-numbered input θ, which can be written as by

$$〈 x \vert C ( θ ) \vert y 〉 = \frac{{P}_{x , y} ( θ )}{Q ( θ )} ∈ {R}_{4 {n}_{mask} , 4 {n}_{mask}} ,$$

where C(θ) is a circuit associated with θ according to a unitary transformation function 206. Given a Cayley interpolation written as M(θ)=Σ_{α=1}ⁿT*f(θh_{α})|ψ_{α} [symbol] [symbol] ψ_{α}|, having an induced unitary map that can be written as can be written as

$$U ( θ ) = \frac{1}{{q}_{θ}} {\sum }_{α = 1}^{n} {u}_{α} ( θ ) * T \vert {ψ}_{α} 〉 〈 {ψ}_{α} \vert ,$$

where q(θ)=Π_{α=1}ⁿ(1−iθh_{α}), u_{α}(θ)=(1+iθh_{α})*Π_{β∈[n]\α}(1−iθh_{β}), P_{x,y}(θ) and Q(θ) can each be polynomials of degree at most 4nₘₐₛₖ. In such instances, | [symbol] x|C(θ)|y [symbol] |² can be a real rational function 308 of degree at most (8nₘₐₛₖ, 8nₘₐₛₖ), and the value of the rational function 308 can be determined (e.g. via error-corrected interpretation) based in part on a known degree of the rational function 308.

FIG. 3 depicts a target gate 310. The target gate 310 can be, comprise, or be comprised by a target gate 202.

FIG. 3 depicts a target result 312. The target result 312 can be, for example, data indicative of any quantum computation result (e.g. quantum measurement result, statistical data aggregating a plurality of quantum measurement results, etc.) associated with a target quantum circuit 102.

In some instances, the target result 312 can be generated based on the rational function 308 and the target gate 310. For example, in some instances one or more target gates 310 can be associated with one or more real numbers θ_{target}, such that when θ_{target} is input into a unitary transformation function 206, a unitary matrix corresponding to a target gate 310 is output. In such instances, the one or more real numbers θ_{target} can be input into the rational function 308 to generate a target result 312.

In some instances, the classical computing system 306 can be, comprise, or be comprised by a classical computing system 104 or a computing system described with respect to FIG. 8-10. In some instances, the classical computing system 306 can comprise, for example, a classical computing device associated with a quantum computing device or quantum computing provider (e.g. a server of a quantum computing provider; a control computer operatively connected to quantum hardware; etc.). In other instances, the classical computing system 306 can comprise, for example, a user device.

FIG. 4 depicts an example quantum computing system 400. The example system 400 is an example of a system on one or more classical computers or quantum computing devices in one or more locations, in which the systems, components, and techniques described below can be implemented. Those of ordinary skill in the art, using the disclosures provided herein, will understand that other quantum computing structures or systems can be used without deviating from the scope of the present disclosure.

The system 400 includes quantum hardware 402 in data communication with one or more classical processors 404. The quantum hardware 402 includes components for performing quantum computation. For example, the quantum hardware 402 includes a quantum system 410, control device(s) 412, and readout device(s) 414 (e.g., readout resonator(s)). The quantum system 410 can include one or more multi-level quantum subsystems, such as a register of qubits. In some implementations, the multi-level quantum subsystems can include superconducting qubits, such as flux qubits, charge qubits, transmon qubits, gmon qubits, etc.

The type of multi-level quantum subsystems that the system 400 utilizes may vary. For example, in some cases it may be convenient to include one or more readout device(s) 414 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 410 via multiple control lines that are coupled to one or more control devices 412. Example control devices 412 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 412 may be configured to operate on the quantum system 410 through one or more respective control parameters (e.g., one or more physical control parameters). For example, in some implementations, the multi-level quantum subsystems may be superconducting qubits and the control devices 412 may be configured to provide control pulses to control lines to generate magnetic fields to adjust the frequency of the qubits.

The quantum hardware 402 may further include readout devices 414 (e.g., readout resonators). Measurement results 408 obtained via measurement devices may be provided to the classical processors 404 for processing and analyzing. In some implementations, the quantum hardware 402 may include a quantum circuit and the control device(s) 412 and readout devices(s) 414 may implement one or more quantum logic gates that operate on the quantum system 402 through physical control parameters (e.g., microwave pulses) that are sent through wires included in the quantum hardware 402. Further examples of control devices include arbitrary waveform generators, wherein a DAC (digital to analog converter) creates the signal.

The readout device(s) 414 may be configured to perform quantum measurements on the quantum system 410 and send measurement results 408 to the classical processors 404. In addition, the quantum hardware 402 may be configured to receive data specifying physical control qubit parameter values 406 from the classical processors 404. The quantum hardware 402 may use the received physical control qubit parameter values 406 to update the action of the control device(s) 412 and readout devices(s) 414 on the quantum system 410. For example, the quantum hardware 402 may receive data specifying new values representing voltage strengths of one or more DACs included in the control devices 412 and may update the action of the DACs on the quantum system 410 accordingly. The classical processors 404 may be configured to initialize the quantum system 410 in an initial quantum state, e.g., by sending data to the quantum hardware 402 specifying an initial set of parameters 406.

The readout device(s) 414 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 414 carries an amplitude and phase shift that depend on the qubit state. In some implementations, a Purcell filter can be used in conjunction with the readout device(s) 414 to impede microwave propagation at the qubit frequency.

In some implementations, the quantum system 410 can include a plurality of qubits 420 arranged, for instance, in a two-dimensional grid 422. For clarity, the two-dimensional grid 422 depicted in FIG. 1 includes 16 qubits arranged in a square formation, however in some implementations the system 410 may include a smaller or a larger number of qubits. In some embodiments, the multiple qubits 420 can interact with each other through multiple qubit couplers, e.g., qubit coupler 424. The qubit couplers can define nearest neighbor interactions between the multiple qubits 420. In some implementations, the strengths of the multiple qubit couplers are tunable parameters. In some cases, the multiple qubit couplers included in the quantum computing system 400 may be couplers with a fixed coupling strength. In some implementations, the multiple qubits 420 may include data qubits, such as qubit 426 and measurement qubits, such as qubit 428. A data qubit is a qubit that participates in a computation being performed by the system 400. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 420 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 420 can be chosen before a computation is performed by the calibration system. Some operating frequencies are better than other operating frequencies. One metric for assessing how good a particular operating frequency is for a particular qubit is energy relaxation time (T1) for the qubit at the frequency. Lower energy relaxation times can lead to larger quantum computational errors.

In various implementations, the example system 400 can be implemented as a client device, a server device, or both. The example system 400 can be implemented as part of a distributed computing system. The example system 400 can be implemented along with other example systems, which may be the same or different. The example system 400 can be implemented in a server farm or other facility that operates multiple computing systems to provide computational services to or on behalf of a plurality of client systems. Advantageously, techniques according to example aspects of the present disclosure can provide for improved calibration and maintenance of computing facilities, increasing service uptime, decreasing failure rates, etc.

### Example Methods

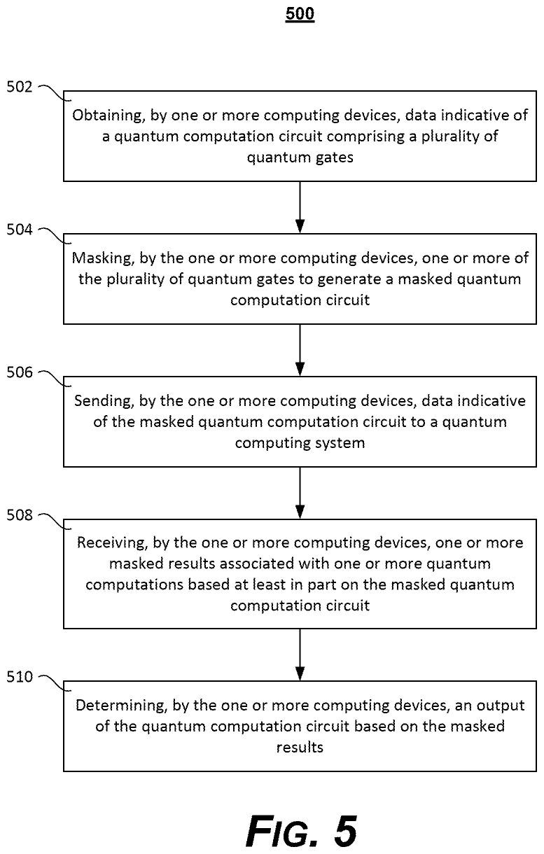

FIG. 5 depicts a flowchart diagram of example method 500 for using a classical computing system to request a masked quantum computation according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, example method 500 can include obtaining, by one or more computing devices, data indicative of a quantum computation circuit comprising a plurality of quantum gates. Obtaining can include, for example, receiving (e.g. from a user, from another computing device, from one or more non-transitory computer-readable media, etc.), generating, or any other means of obtaining. In some instances, the quantum computation circuit can be, comprise, or be comprised by a target quantum circuit 102. In some instances, step 502 can include one or more steps described with respect to FIG. 1.

At 504, example method 500 can include masking, by the one or more computing devices, one or more of the plurality of quantum gates to generate a masked quantum computation circuit. In some instances, the masked quantum computation circuit can be, comprise, or be comprised by a masked quantum circuit 106. In some instances, step 504 can include one or more steps described with respect to FIG. 1 or FIG. 2.

At 506, example method 500 can include sending, by the one or more computing devices, data indicative of the masked quantum computation circuit to a quantum computing system. In some instances, the data indicative of the masked quantum computation circuit can be, comprise, or be comprised by a masked quantum circuit 106. In some instances, the quantum computing system can be, comprise, or be comprised by a quantum computing system 108. In some instances, step 506 can comprise one or more steps described with respect to FIG. 1.

At 508, example method 500 can include receiving, by the one or more computing devices, one or more masked results associated with one or more quantum computations based at least in part on the masked quantum computation circuit. In some instances, the masked results can be, comprise, or be comprised by masked results 110. In some instances, step 508 can comprise one or more steps described with respect to FIG. 1.

At 510, example method 500 can include determining, by the one or more computing devices, an output of the quantum computation circuit based on the masked results. In some instances, the output of the quantum computation circuit can be, comprise, or be comprised by one or more target quantum computation results 112. In some instances, step 510 can comprise one or more steps described with respect to FIG. 1.

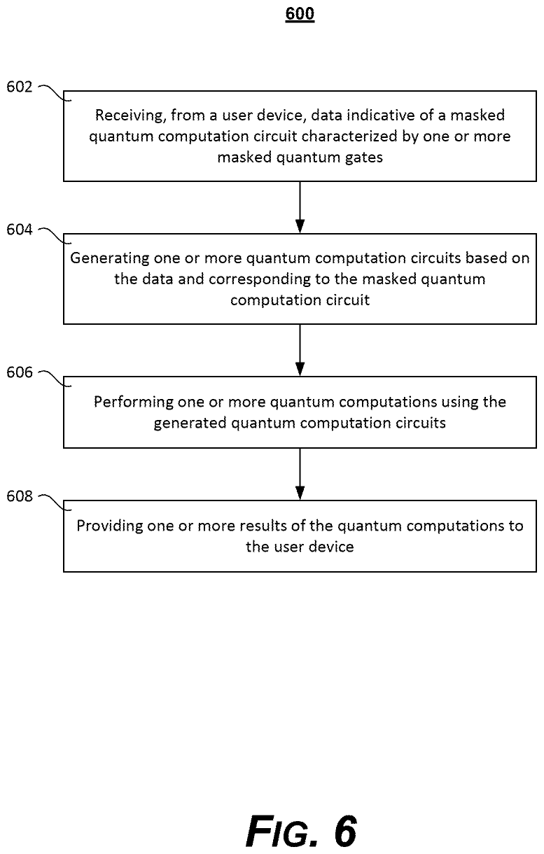

FIG. 6 depicts a flowchart diagram of an example method for using a quantum computing system to perform a masked quantum computation according to example embodiments of the present disclosure. Although FIG. 6 depicts steps performed in a particular order for purposes of illustration and discussion, the methods of the present disclosure are not limited to the particularly illustrated order or arrangement. The various steps of example method 600 can be omitted, rearranged, combined, and/or adapted in various ways without deviating from the scope of the present disclosure.

At 602, example method 600 can include receiving, from a user device, data indicative of a masked quantum computation circuit characterized by one or more masked quantum gates. In some instances, the user device can be, comprise, or be comprised by a classical computing system 104. In some instances, the data indicative of the masked quantum circuit can be, comprise, or be comprised by a masked quantum circuit 106. In some instances, step 602 can comprise one or more steps described with respect to FIG. 1.

At 604, example method 600 can include generating one or more quantum computation circuits based on the data and corresponding to the masked quantum computation circuit. In some instances, step 604 can include generating a quantum computation that is similar to, but not the same as, the masked quantum computation circuit. For example, in some instances the masked quantum computation circuit can comprise a first masked gate 204, and step 604 can include generating a quantum computation circuit having an additional masked gate 210 in place of the first masked gate 204. In some instances, step 604 can be performed using a quantum computing system 108 or quantum computing system 400. In some instances, step 604 can include one or more steps discussed with respect to FIG. 4.

At 606, example method 600 can include performing one or more quantum computations using the generated quantum computation circuits. In some instances, step 606 can be performed using a quantum computing system 108 or quantum computing system 400. In some instances, step 606 can include one or more steps discussed with respect to FIG. 4.

At 608, example method 600 can include providing one or more results of the quantum computations to the user device. In some instances, the results can be, comprise, or be comprised by masked results 110. In some instances, step 608 can include one or more steps described with respect to FIG. 1.

FIG. 7 depicts an example method 700 for performing a quantum computation using a quantum circuit according to example aspects of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure. The method 700 can be implemented by any suitable computing system, such as a quantum computing system including quantum hardware in communication with one or more quantum control devices, such as quantum computing system 400 of FIG. 4.

At 702, example method 700 can include obtaining data indicative of a quantum circuit. Obtaining data can include, for example, receiving data from a computing device (e.g. user device, server device); receiving data from a user (e.g. via input/output device); reading data from one or more non-transitory computer-readable media; generating data (e.g. using an algorithm); etc. Data indicative of a quantum circuit can include, for example, a circuit design, circuit diagram, one or more unitary matrices, software code (e.g. quantum software code in a quantum computing language), etc. In some instances, data indicative of a quantum circuit can include data indicative of a masked quantum circuit 106.

At 704, example method 700 can include preparing one or more qubits in a known quantum state. Preparing one or more qubits in a known quantum state can include, for example, preparing one or more qubits in a known basis state (e.g. by manipulating a plurality of qubits such that qubits characterized by a particular basis state, e.g. |0 [symbol] or |1 [symbol] , can be separated from qubits not characterized by that basis state (e.g. physically separated, separately identified, etc.). Preparing one or more qubits in a known quantum state can include, for example, using a control device 412 to perform quantum gating to generate a known multi-qubit basis state. Preparing one or more qubits can include using a control device 412 in a manner described with respect to FIG. 4.

At 706, example method 700 can include applying one or more quantum gates to one or more qubits to execute a quantum algorithm. For example, in some instances control devices 412 can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc., in a manner described with respect to FIG. 4

At 708, example method 700 can include measuring, using a readout apparatus, a state of at least one of the one or more qubits. The readout apparatus can be, for example, a readout device 414, and step 706 can in some instances be performed in a manner described with respect to FIG. 4.

### Example Classical Computing Systems

FIG. 8 depicts a block diagram of an example computing system that can perform aspects of example embodiments of the present disclosure. The system includes a computing device 50, a server computing system 60, and a third-party system 70 that are communicatively coupled over a network 49. The system also includes a quantum computing system 80 that is communicatively coupled to the server computing system.

The computing device 50 can be any type of computing device (e.g., classical computing device), such as, for example, a mobile computing device (e.g., smartphone or tablet), a personal computing device (e.g., laptop or desktop), a workstation, a cluster, a gaming console or controller, a wearable computing device, an embedded computing device, or any other type of computing device. In some embodiments, the computing device 50 can be a client computing device. The computing device 50 can include one or more processors 51 and a memory 52. The one or more processors 51 can be any suitable processing device (e.g., a processor core, a microprocessor, an ASIC, an FPGA, a controller, a microcontroller, etc.) and can be one processor or a plurality of processors that are operatively connected. The memory 52 can include one or more non-transitory computer-readable media, such as RAM, ROM, EEPROM, EPROM, flash memory devices, magnetic disks, etc., and combinations thereof. The memory 52 can store data 53 and instructions 54 which are executed by the processor 51 to cause the user computing device 50 to perform operations as described herein.

The computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The quantum computing system 80 can include one or more processors 81 (e.g., classical processor(s) 104) and a memory 82. The one or more processors 81 can be any suitable processing device (e.g., a processor core, a microprocessor, an ASIC, an FPGA, a controller, a microcontroller, etc.) and can be one processor or a plurality of processors that are operatively connected. The memory 82 can include one or more non-transitory computer-readable storage media, such as RAM, ROM, EEPROM, EPROM, flash memory devices, magnetic disks, etc., and combinations thereof. The memory 82 can store data 83 and instructions 84 which are executed by the processor 81 to cause the quantum computing system 80 to perform operations as described herein.

The quantum computing system 80 can also include a quantum system 85 for performing quantum computations. In some instances, the quantum system 85 can be, comprise, or be comprised by quantum hardware 402, described above with reference to FIG. 4.

In some implementations, the quantum computing system can 85 include or be otherwise implemented by one or more server computing systems 60. In instances in which the quantum computing system 80 includes plural server computing devices, such server computing devices can operate according to sequential computing architectures, parallel computing architectures, or some combination thereof. In some implementations, the quantum computing system 80 can be associated with or operated by a quantum computation service provider. In some instances, a quantum computation service may perform one or more quantum computations desired by a user, and one or more outputs generated using the quantum computing system 80 may be provided to the user in association with the quantum computation service.

The third-party system 70 can include one or more processors 71 and a memory 72. The one or more processors 71 can be any suitable processing device (e.g., a processor core, a microprocessor, an ASIC, an FPGA, a controller, a microcontroller, etc.) and can be one processor or a plurality of processors that are operatively connected. The memory 72 can include one or more non-transitory computer-readable storage media, such as RAM, ROM, EEPROM, EPROM, flash memory devices, magnetic disks, etc., and combinations thereof. The memory 72 can store data 73 and instructions 74 which are executed by the processor 71 to cause the third-party system 70 to perform operations. In some implementations, the third-party system 70 includes or is otherwise implemented by one or more server computing devices.

The server computing system 60 can include one or more processors 61 and a memory 62. The one or more processors 61 can be any suitable processing device (e.g., a processor core, a microprocessor, an ASIC, an FPGA, a controller, a microcontroller, etc.) and can be one processor or a plurality of processors that are operatively connected. The memory 62 can include one or more non-transitory computer-readable storage media, such as RAM, ROM, EEPROM, EPROM, flash memory devices, magnetic disks, etc., and combinations thereof. The memory 62 can store data 63 and instructions 64 which are executed by the processor 61 to cause the server computing system 60 to perform operations. In some implementations, the server computing system 60 includes or is otherwise implemented by one or more server computing devices.

The network 49 can be any type of communications network (e.g., classical or quantum), such as a local area network (e.g., intranet), wide area network (e.g., Internet), or some combination thereof and can include any number of wired or wireless links. In general, communication over the network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

FIG. 8 illustrates one example computing system that can be used to implement the present disclosure. Other computing systems can be used as well. For example, in some implementations, the quantum computing system 80 can include the server computing system 60 or vice versa. In some implementations, the quantum computing system 80 may be communicatively coupled through the network 49 to the computing device 50, third-party system 70, or server computing system 60.

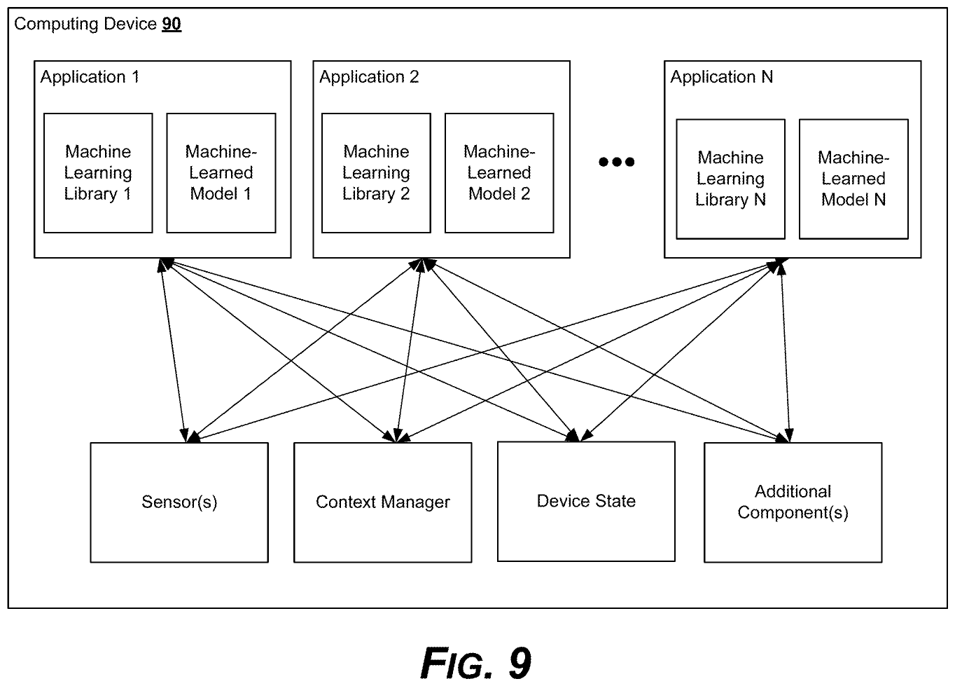

FIG. 9 depicts a block diagram of an example computing device 90 that performs according to example embodiments of the present disclosure. The computing device 90 can be a client computing device or a server computing device. The computing device 90 can include a number of applications (e.g., applications 1 through N). Each application can contain its own machine learning library and machine-learned model(s). For example, each application can include a machine-learned model. Example applications include a word processing application, an email application, a browser application, an application configured for scientific computation, an application configured to communicate with one or more quantum computing systems, etc. As illustrated in FIG. 9, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

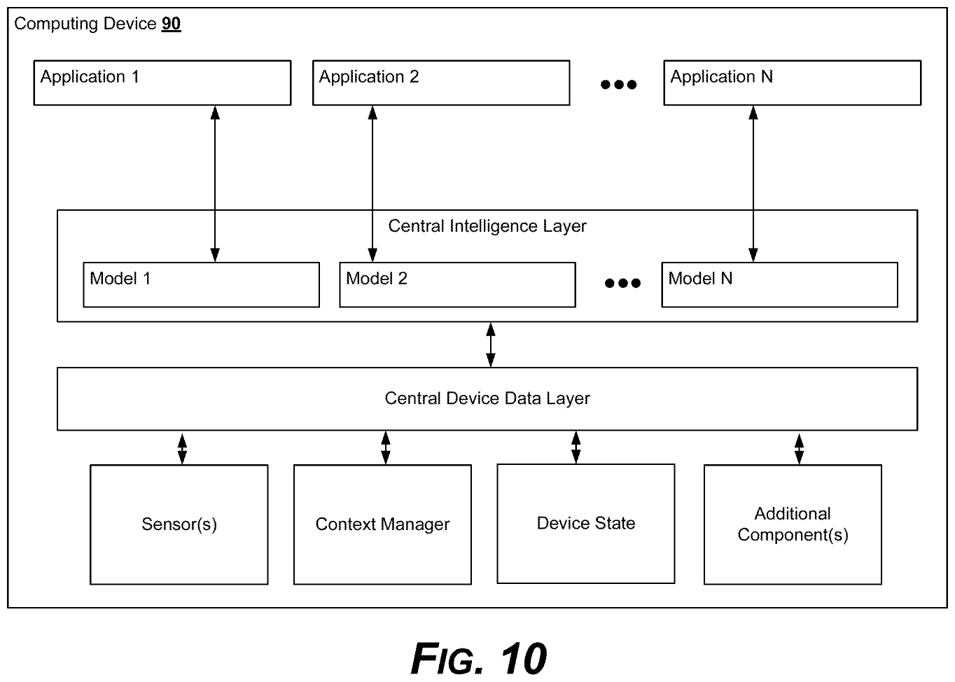

FIG. 10 depicts a block diagram of an example computing device 90 that performs according to example embodiments of the present disclosure. The computing device 90 can be a user computing device or a server computing device. The computing device 90 can include a number of applications (e.g., applications 1 through N). Each application is in communication with a central intelligence layer. Example applications include a word processing application, an email application, a browser application, an application configured for scientific computation, an application configured to communicate with one or more quantum computing systems, etc. In some implementations, each application can communicate with the central intelligence layer (and model(s) stored therein) using an API (e.g., a common API across all applications).

The central intelligence layer can include a number of machine-learned models. For example, as illustrated in FIG. 10, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 90.

The central intelligence layer can communicate with a central device data layer. The central device data layer can be a centralized repository of data for the computing device 80. As illustrated in FIG. 10, the central device data layer can communicate with a number of other components of the computing device, such as, for example, one or more sensors, a context manager, a device state component, or additional components. In some implementations, the central device data layer can communicate with each device component using an API (e.g., a private API).

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs (e.g., one or more modules of digital and/or quantum computer program instructions encoded on a tangible non-transitory storage medium for execution by, or to control the operation of, data processing apparatus). The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit (i.e., a system that defines the unit of quantum information). It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A method, comprising:
obtaining, by one or more computing devices, data indicative of a quantum computation circuit comprising a plurality of quantum gates;
masking, by the one or more computing devices, one or more of the plurality of quantum gates to generate a masked quantum computation circuit;
sending, by the one or more computing devices, data indicative of the masked quantum computation circuit to a quantum computing system;
receiving, by the one or more computing devices, one or more masked results associated with one or more quantum computations based at least in part on the masked quantum computation circuit; and
determining, by the one or more computing devices, an output of the quantum computation circuit based on the masked results.

2. The method of claim 1, wherein masking comprises determining a masked gate based on random sampling.

3. The method of claim 1, wherein each of the one or more quantum gates is characterized by a unitary matrix having a number of rows and a number of columns, and masking comprises:
obtaining, by the one or more computing devices, a masking function, wherein a range of the masking function comprises the unitary matrix of the quantum gate and one or more other unitary matrices having the number of rows and the number of columns; and
determining, by the one or more computing devices, a masked gate based on the masking function, wherein the masked gate is characterized by at least one of the one or more other unitary matrices.

4. The method of claim 3, wherein:
a domain of the masking function comprises one or more real numbers; and
determining a masked gate comprises determining a real number and determining, based on the real number, one or more unitary matrices.

5. The method of claim 4, wherein the masking function comprises a Cayley function.

6. The method of claim 1, wherein determining the output of the quantum computation circuit comprises:
obtaining one or more functions indicative of a relationship between a plurality of output values and a plurality of quantum circuits; and
determining, based on the one or more functions and the quantum computation circuit, an output value associated with the quantum computation circuit.

7. The method of claim 6, wherein obtaining the one or more functions indicative of the relationship comprises receiving, by the one or more computing devices, data indicative of the one or more functions.

8. The method of claim 6, wherein obtaining the one or more functions indicative of the relationship comprises:
receiving, by the one or more computing devices, a plurality of quantum computation measurements; and
performing, by the one or more computing devices and based on the plurality of quantum computation measurements, an error-corrected interpolation.

9. The method of claim 6, wherein at least one of the one or more functions indicative of the relationship is a rational function.

10. The method of claim 1, further comprising:
obtaining a precision associated with the masked results; and
determining, based on the precision associated with the masked results, a precision associated with the output of the quantum computation circuit.

11. The method of claim 1, further comprising:
obtaining a precision goal associated with the quantum computation circuit;
based on the precision goal associated with the quantum computation circuit and a measure of a difference between the masked circuit and the quantum circuit, determining, by the one or more computing devices, a masked precision goal associated with the masked circuit; and
sending, by the one or more computing devices, data indicative of the masked precision goal.

12. The method of claim 1, further comprising:
performing, by the one or more computing devices, a simulation of at least a portion of the masked quantum computing circuit; and
verifying the masked results based on a comparison between the masked results and a result of the simulation.

13. A method for providing a quantum computation service without knowing details of the quantum computation desired by a user, comprising:
receiving, from a user device, data indicative of a masked quantum computation circuit characterized by one or more masked quantum gates;
generating one or more quantum computation circuits based on the data and corresponding to the masked quantum computation circuit;
performing one or more quantum computations using the generated quantum computation circuits;
providing one or more results of the quantum computations to the user device.

14. The method of claim 13, further comprising:
receiving a precision goal associated with the masked quantum computation circuit;
determining, based on the precision goal, a number of quantum computations to perform; and
performing the number of quantum computations using the generated quantum computation circuits.

15. The method of claim 13, further comprising:
determining, based on the one or more quantum computations, a function indicative of a relationship between a plurality of quantum gates and a plurality of output values;
wherein the one or more results comprises the function indicative of the relationship.

16. The method of claim 15, wherein determining the function indicative of the relationship comprises performing an error-corrected interpolation.

17. One or more non-transitory computer-readable media storing instructions that are executable by one or more processors to perform one or more operations, the operations comprising:
obtaining data indicative of a quantum computation circuit comprising a plurality of quantum gates;
masking one or more of the plurality of quantum gates to generate a masked quantum computation circuit;
sending, to a quantum computing system, data indicative of the masked quantum computation circuit;
receiving one or more masked results associated with one or more quantum computations based at least in part on the masked quantum computation circuit; and
determining, based on the masked results, an output of the quantum computation circuit.

18. The non-transitory computer-readable media of claim 17, wherein each of the one or more quantum gates is characterized by a unitary matrix having a number of rows and a number of columns, and masking comprises:
obtaining a masking function, wherein a range of the masking function comprises the unitary matrix of the quantum gate and one or more other unitary matrices having the number of rows and the number of columns; and
determining a masked gate based on the masking function, wherein the masked gate is characterized by at least one of the one or more other unitary matrices.

19. The non-transitory computer-readable media of claim 17, wherein determining the output of the quantum computation circuit comprises:
obtaining one or more functions indicative of a relationship between a plurality of output values and a plurality of quantum circuits; and
determining, based on the one or more functions and the quantum computation circuit, an output value associated with the quantum computation circuit.

20. The non-transitory computer-readable media of claim 17, wherein the operations further comprise:
obtaining a precision associated with the masked results; and
determining, based on the precision associated with the masked results, a precision associated with the output of the quantum computation circuit.
